(19) United States
(12) Patent Application Publication
(10) Pub. No.: US 2016/0358682 A1
(43) Pub. Date: Dec. 8, 2016

(54) CONTAINER

(71) Applicant: NUCLEAR CARGO + SERVICE GMBH, Hanau (DE)

(72) Inventors: Franz HILBERT, Wiesbaden (DE); Salaheddine REZGUI, Hanau-Steinheim (DE)

(21) Appl. No.: 14/564,596

(22) Filed: Dec. 9, 2014

(30) Foreign Application Priority Data
Dec. 10, 2013 (DE) 102013113785.7

(51) Int. Cl. G21F 5/008; G21F 5/12; G21F 1/08; B65D 53/06; B65D 39/08

(52) U.S. Cl. CPC G21F 5/008; B65D 53/06; B65D 39/08; G21F 1/08; G21F 5/12

(57) ABSTRACT

The invention concerns a container (10), in particular to hold radioactive substances such as UF₆, with a peripheral wall (12) extending between the ends of the container, such as concave ends (14, 16), and enclosing the interior (13) of the container, in particular in the form of a hollow cylinder, wherein in the interior (13) of the container (10), multiple fitted elements (20, 22, 24) spaced apart from each other are arranged, which contain at least one neutron-trapping material or consist at least partially of it, To increase the criticality safety, it is provided that the fitted elements (20, 22, 24) penetrate at least one of the ends (14, 16) and are connected to it.

The invention concerns a container, in particular to hold radioactive substances such as UF₆, with a peripheral wall extending between the ends of the containers, such as concave ends, and enclosing the interior of the container, in particular in the form of a hollow cylinder, wherein in the interior of the container, a number of fitted elements spaced apart from each other are arranged, which either contain at least one neutron-trapping material or consisting at least partially of a neutron-trapping material.

The overwhelming majority of the nuclear power stations operated worldwide today are fuelled by uranium enriched with maximum 5.0% by weight of ²³⁵U in uranium. The enrichment of the uranium by the natural enrichment of around 0.71% by weight of ²³⁵U in uranium to up to 5.0% by weight of ²³⁵U in uranium takes place in enrichment installations in the chemical form of uranium hexafluoride (UF₆). The transportation of the enriched uranium from the enrichment installations to the fuel element manufacturer likewise takes place in the chemical form UF₆. The enriched UF₆ is filled into 30B cylinders in the enrichment installation.

30B cylinders are specified in ISO 7195 “Nuclear energy—Packaging of uranium hexafluoride (UF₆) for transport” and in the US standard ANSI N14.1-2012 “For Nuclear Materials—Uranium Hexafluoride—Packagings for Transport”. They can hold a maximum mass of 2,277 kg UF₆.

These 30B cylinders are transported in each case in a so-called “protective structural packaging” (PSP), which together with the cylinder meet the requirements of the IAEA guidelines for the transport of radioactive substances “Regulations for the Safe Transport of Radioactive Material” SSR-6, and the international and national hazardous goods provisions derived therefrom.

The development of new reactor types calls for the provision of uranium enriched with more than 5.0% by weight of ²³⁵U in uranium as fuel. For this enrichment, in ISO 7195 and ANSI N14.1-2012, the cylinder types 8A with a capacity of around 115 kg UF₆ and an enrichment of up to 12.5% by weight of ²³⁵U, and 5B with a capacity of around 25 kg and an enrichment of up to 100% by weight of ²³⁵U in uranium are specified.

The cylinder type 30 B cannot be used to transport UF₆ with a higher enrichment than 5.0% by weight of ²³⁵U in uranium because it does not meet the requirements of the aforesaid SSR-6 guidelines for higher enrichments.

The use of cylinder types 8A and 5B has the following serious economic and technical drawbacks:

The cylinder types 8A and 5B differ greatly from the cylinder type 30B used hitherto in terms of their external dimensions, connections and handling. Thus, with the use of cylinder types 8A and 5B, new filling/emptying stations would need to be built and operated both at the enrichment installations and also at the fuel element manufacturers. The entire logistics within the operation would also have to be adapted.
Due to the small capacity of the cylinder types 8A and 5B, far more handling operations and transport operations are required compared to the use of the 30B cylinder.
Currently, neither the cylinder types 8A and 5B nor the PSPs suitable for them are available in a relevant quantity so a costly new-build would be necessary.

In the case of a container according to GB 855 420 A, either hollow cylinders or honeycomb lattice arranged randomly in the container are provided which are arranged on a grille-type support.

From DE 43 08 612 A1, a material made of an aluminium based alloy is known, which is to be used for absorber rods or transport devices and contains boron.

Transport and storage containers for radioactive materials can be found in EP 0 116 412 A1, U.S. Pat. No. 4,292,528 A and DE 693 25 725 T2. Here, the containers have fittings which absorb neutrons.

The task of the present invention is to further develop a container which is suitable for transporting fissile radioactive substances, in particular enriched uranium containing UF₆, such that the criticality safety can be increased without needing to change the external dimensions of the container.

To resolve the task, it is basically provided that the fitted elements penetrate at least one of the ends and are connected thereto.

By the teaching according to the invention, a container is improved in terms of its criticality safety by the neutron-trapping fitted elements arranged in it, so that a container for transporting fissile radioactive materials with a higher reactivity can be used, which per se should only be loaded with less reactive fissile material. A transport system is made available which thus avoids the previously described disadvantages and can draw on tested and known technical solutions, such as containers of the type 30B cylinders to ISO 7195.

It is known that materials containing boron are used to test for reactivity and to guarantee sub-criticality. According to the invention, it is proposed that the neutron-trapping material is boron, preferably in the form of boron carbide in the event of it being present in a matrix such as polyethylene, whereby in particular boron in its natural isotope composition is to be preferred. It is of course also possible to use boron in a non-natural composition, i.e. boron with a higher content of B¹⁰ isotopes. It is provided in particular that boron is present as B¹⁰ with a % by weight content of between 18.43 (natural content) and 100.

Moreover there is the possibility that the material of the fitted elements themselves contain boron as elementary boron, or the fitted elements are filled with the material, wherein said materials contain boron, e.g. in the form of boron carbide.

Regardless of this, it is preferably provided that, where tubes are used as the fitted elements, they have an external diameter of 50 mm to 70 mm and a wall thickness in the range of 2 mm to 5 mm. If rods containing elemental boron are used as fitted elements, diameters of 50 mm to 60 mm are to be preferred.

If panels are used to trap the neutrons, they should preferably be between 5 mm and 6 mm thick. Moreover, the panels extend over the entire width of the container, consequently dividing it into regions wherein in particular the panels run parallel to each other. In the panels themselves, there should be drilled holes so that the material introduced in the container can distribute throughout the container.

The volume content of the tubes or rods should stand at 25% to 40% of the interior of the container. The preferred figure stands at around 32%.

The volume content of the panels should preferably stand at 10% to 20% of the internal volume of the container.

On the basis of the teaching according to the invention, the % by weight of ²³⁵U can be as much at 59% provided that the boron content stands at 20% by weight in the polyethylene which is filled into the tubes, and there is 100% by weight of B¹⁰ isotopes in the boron.

If only boron with a natural proportion of B¹⁰ isotopes, i.e. with a % by weight of 18.43, is held by the polyethylene, wherein the % by weight of the boron is likewise 20, the % by weight of ²³⁵U in the UF₆ is 27%.

If the boron content in the polyethylene stands at 10% by weight, then with a B¹⁰ isotope content of 100% by weight, the % by weight of ²³⁵U can stand at 44% by weight, and if boron with a natural B¹⁰ content, i.e. 18.43% by weight, is used, the % by weight of ²³⁵U in UF₆ can stand at 22%.

If the boron content in the polyethylene stands at 5% by weight, then with a B¹⁰ isotope content of 100% by weight, this results in a % by weight of ²³⁵U of 34 in uranium, and with an exclusively natural content of the B¹⁰ isotope (18.43% by weight), a % by weight content of ²³⁵U of 17. By these measures, the criticality safety is met.

The relationships between the boron content in the polyethylene, the isotope B¹⁰ content and the greatest possible uranium enrichment are shown in the table below:

| | | Highest possible uranium |
|---|---|---|
| Boron content | B-10 isotope | enrichment in the UF₆ at |
| in polyethylene | content in boron | criticality safety |
| % by weight | % by weight | % by weight of U-235 in uranium |
| 5 | 18.43 (natural) | 17 |
| | 20 | 18 |
| | 30 | 20 |
| | 40 | 22 |
| | 50 | 24 |
| | 60 | 27 |
| | 70 | 29 |
| | 80 | 31 |
| | 90 | 32 |
| | 100 | 34 |
| 10 | 18.43 (natural) | 22 |
| | 20 | 23 |
| | 30 | 26 |
| | 40 | 30 |
| | 50 | 34 |
| | 60 | 36 |
| | 70 | 39 |
| | 80 | 41 |
| | 90 | 43 |
| | 100 | 44 |
| 20 | 18.43 (natural) | 27 |
| | 20 | 30 |
| | 30 | 35 |
| | 40 | 39 |
| | 50 | 44 |
| | 60 | 48 |
| | 70 | 51 |
| | 80 | 54 |
| | 90 | 57 |
| | 100 | 59 |

A filling is preferably introduced into the fitted elements, wherein the filing consists of a moderator material such as polyethylene, to which a neutron absorber such as boron has been added.

On the basis of the teaching according to the invention, in particular the tested cylinder type 30B used worldwide can be modified in such a way that UF₆ with an enrichment of over 5.0% by weight of ²³⁵U in uranium can also be transported.

It is provided in particular that the fitted elements are welded to the ends. It is consequently only essential for drilled holes to be made in the ends which are penetrated by the fitted elements.

The fitted elements themselves can be those from the group comprising tubes, rods, panels and metal strips, wherein at least the rod, panel and strip contain the neutron-trapping elements, such as boron, i.e. can be made of a material with neutron-trapping elements.

It is provided in particular for multiple tubes to be welded parallel to the container axis, wherein said tubes are filled with materials containing boron, for example polyethylene containing boron. The correspondingly filled tubes are sealed at their ends. Moreover, it is in particular provided that lids or stoppers are used which are welded to the tubes or screwed onto them.

With corresponding tubes filled with materials containing boron, the criticality safety is guaranteed in the containers according to the invention with an ingress of water to be assumed according to the previously stated SSR-6 directives.

Instead of the tubes filled with materials containing boron, tubes made of steel containing boron with a filling made of a moderator material (e.g. polyethylene) can be used. Instead of tubes, solid rods or panels made of steel can also be used, which themselves contain boron and, depending on their form, are fastened to the concave ends or to the jacket of the container. Boron with a non-natural isotope composition, e.g. boron with a higher content of B¹⁰, can also be used in the polyethylene, the tubes, rods or panels.

The fittings according to the invention, e.g. in a 30B type cylinder to ISO 7195, recognisably have the following economic and technical advantages:

Both in the enrichment plants and also at the fuel element manufacturers, the filling/emptying stations used hitherto for the cylinder type 30B can be used; an adaptation of the operation's internal logistics is not necessary;
The capacity of the container according to the invention is far greater than the capacity of the cylinder types 8A and 5B; the number of handling operations and transport operations is accordingly far lower than with cylinder types 8A and 5B;
For the containers according to the invention, the same protective structural packaging (PSP) can be used as for the cylinder type 30B; a sufficient number is available for the worldwide demand.

A possible parameter combination for a container according to the invention with dimensions of the type 30B to ISO 7195 with a maximum enrichment of 10.0% by weight of ²³⁵U in uranium are for example tubes arranged in the grid, having an external diameter of 60 mm, a wall thickness of 3 mm and a filling of polyethylene containing boron, having a 5% by weight of boron with a natural isotope composition. Provided in particular is for the fitted elements of the container according to the invention to be arranged distributed evenly on concentric circles, wherein the fitted elements are arranged so that they are spaced equidistantly to each other on the particular circle. It is furthermore possible to position a fitted element along the longitudinal axis of the container.

While boron is preferably named as the neutron-trapping element, other corresponding elements such as cadmium can also be considered.

While the fitted elements are preferably connected to the ends of the container, in particular by the fitted elements penetrating the ends and being welded to them, this does not depart from the invention if the fitted elements are not or not only connected indirectly or directly to the ends, but also to the internal wall of the peripheral wall of the container forming a hollow cylinder.

Nor is there a departure from the invention if the fitted elements do not run parallel to each other and in particular parallel to the longitudinal axis of the container, but in part crosswise to each other.

Further details, advantages and features of the invention arise not only from the claims, the features to be found in them—individually and/or in combination—but also from following description of preferred examples of embodiments found in the drawing.

The following are shown:

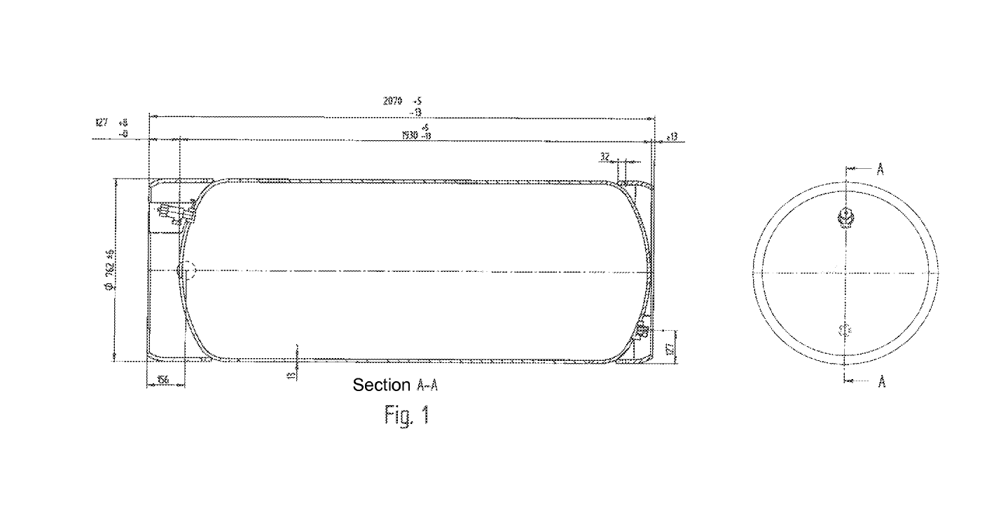

FIG. 1 a container of the type 30B cylinder to ISO 7195: 2004(E);

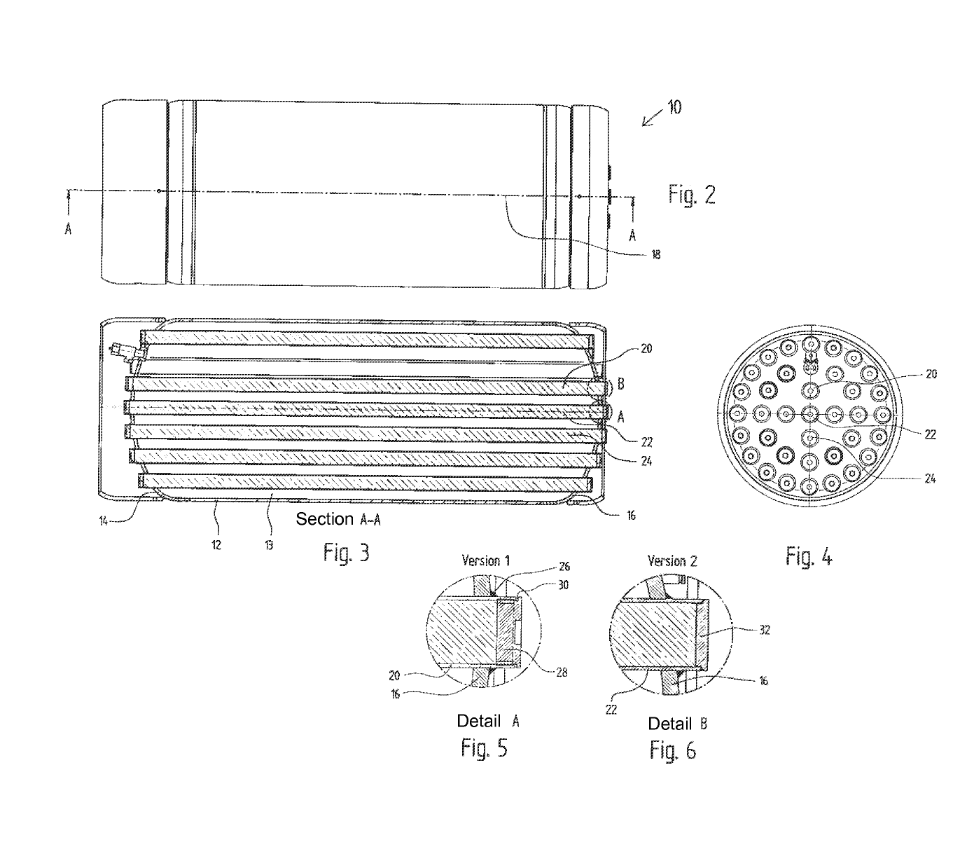

FIG. 2 a container according to the invention;

FIG. 3 a section along the line A-A in FIG. 2;

FIG. 4 a view of the valve-side face of the container according to FIGS. 2 and 3;

FIG. 5 a detail A of FIG. 3; and

FIG. 6 a detail B of FIG. 3.

The teaching according to the invention is described using a container of the type 30 B cylinder to ISO 7195. Even where a case of the priority application is involved, the teaching according to the invention is not restricted by this. Instead, this offers for transport containers of radioactive materials quite generally the possibility of improving containers in terms of their criticality safety by simple measures, without requiring changes to the basic structure of the containers themselves. Instead, it is only necessary to arrange in the interior of the container, fitted elements which for their part contain elements, in particular boron, in order to trap neutrons.

FIG. 1 shows a container of the type 30B cylinder together with its dimensions, as shown in FIG. 8 of ISO 7195. A container in this regard is further developed according to the invention, as can be seen in FIGS. 2 to 6.

FIG. 2 shows an external view of a container 10 according to the invention, which does not differ from a container of the type 30B cylinder to ISO 7195. As illustrated by FIG. 2 and the section drawing according to FIG. 3, the container 10 has a peripheral wall 12 with a hollow cylinder geometry enclosing the interior 13 of the container 10, said peripheral wall being ended on its ends by ends 14, 16 in the form of concave ends, which for their part are welded to the peripheral wall 12. In contrast to the container according to FIG. 1, the container 10 according to the invention has fitted elements which in the example of the embodiment extend parallel to the longitudinal axis 18 of the container 10 and penetrate the concave ends 14, 16. For example, three fitted elements are labelled with the reference numbers 20, 22 and 24.

In the example of an embodiment, the fitted elements 20, 22, 24 are tubes which extend over the entire length of the container 10 and penetrate drilled holes in the concave ends 14, 16 and are welded to the concave ends 14, 16 in these regions, as can be seen in the detailed drawings in FIGS. 5 and 6.

Thus, in FIG. 5, the concave end 16 is shown as a detail, which is penetrated by the tube 20 and is welded to the former (weld seam 26). The tube 22 is correspondingly connected to the concave end 14 (FIG. 6). To increase the criticality safety, the tubes 20, 22—like the other fitted elements—are filled with a moderator material such as polyethylene in which there are neutron-trapping elements, such as boron. Moreover, the boron can be present with a non-natural isotope composition, i.e. boron with a higher content of B¹⁰. The tube 20 thus filled is then sealed tight with a closure element such as a lid 28 which is screwed into the tube 20 and can be sealed from it by means of a seal 30. It is however also possible to close the fitted elements 20, 22, 24 after filling with the moderator material containing in particular boron by means of a lid 32 which is welded to the tube, in accordance with the example of an embodiment with the tube 22.

The material of the tubes 20, 22, 24 can be steel. The steel can moreover itself contain boron or other neutron-trapping elements.

The concentration of the neutron-trapping elements, i.e. in particular the boron concentration, is set in the materials depending on the criticality to be observed, so that there is the possibility of transporting in particular uranium hexafluoride with an enrichment of over 5% by weight of ²³⁵U with the container 10 according to the invention corresponding to the container of type 30B cylinder.

From the view according to FIG. 4, in which the face having a valve is illustrated, it is clear that the fitted elements 20, 22, 24 formed as tubes can be arranged on circles running concentrically to each other, wherein the centre points of said circles lie on the longitudinal axis 18 of the container 10. Moreover it is in particular provided that the tubes 20, 22, 24 are arranged equidistantly from each other on the particular circles, although this is not an essential feature.

The tubes 22, 24, 26 can have an external diameter of 50 mm to 70 mm, in particular 60 mm, with a wall thickness of 2 mm to 4 mm, in particular 3 mm. The filling can be made of polyethylene containing boron, at 5% by weight to for example 30% by weight boron content. Moreover, the boron can be enriched with the isotope B¹⁰ up to 100% by weight.

The % by weight data are to be understood such that 100% by weight is the total weight of the moderator material such as polyethylene and the neutron-trapping material such as boron in particular.

Instead of tubes, rod-shaped solid materials or also panels can be used as the fitted elements, which can likewise be connected to the concave bases 14, 16. A connection to the internal wall of the hollow cylindrical peripheral wall 12 can likewise be possible. At least where solid material is used, i.e. fitted elements which do not have any filling, the former are made of materials which contain neutron-trapping elements such as elemental boron.

1. Container (10), in particular to hold radioactive substances such as UF₆, with a peripheral wall (12) extending between the ends of the containers, such as concave ends (14, 16), and enclosing the interior (13) of the container, in particular in the form of a hollow cylinder, wherein in the interior (13) of the container (10), multiple fitted elements (20, 22, 24) spaced apart from each other are arranged, which either contain at least one neutron-trapping material or consisting at least partially a neutron-trapping material,
characterised in that
the fitted elements (20, 22, 24) penetrate at least one of the ends (14, 16) and are connected thereto.

2. Container according to claim 1,
characterised in that
the fitted elements (20, 22, 24) penetrate both ends (14, 16).

3. Container according to claim 1,
characterised in that
the fitted elements (20, 22, 24) are welded to the end or ends (14, 16).

4. Container according to claim 1, characterised in that
the fitted elements (20, 22, 24) are tube-shaped fitted elements.

5. Container according to claim 1, characterised in that
the fitted elements (20, 22, 24) run in a longitudinal direction of the container (10), in particular parallel to its longitudinal axis (10).

6. Container according to claim 1, characterised in that
the fitted elements (20, 22, 24) are filled with moderator material containing neutron-trapping elements as the material and are closed at the ends.

7. Container according to claim 1, characterised in that
the fitted elements (20, 22, 24) formed as tubes are closed by means of closure elements such as welded lids (32) and/or screwed-in stoppers (28).

8. Container according to claim 1, characterised in that
the fitted elements (20, 22, 24) are arranged so that they are distributed evenly on circles running concentrically to each other, wherein the fitted elements are arranged spaced equidistantly from each other on the particular circle.

9. Container according to claim 1, characterised in that
the neutron-trapping material contains boron or cadmium.

10. Container according to claim 1, characterised in that
the fitted elements (20, 22, 24) are filled with a moderator material, such as polyethylene containing boron.

11. Container according to claim 9, characterised in that
the boron is enriched with B¹⁰ isotopes, in particular with 18.34 to 100% by weight B¹⁰.

12. Container according to claim 1, characterised in that
the fitted element (22, 24, 26) is a fitted element from the group containing a tube (20, 22, 24) filled with the neutron-trapping material, solid rods, panels and strips, and wherein at least the rod, panel, strip contain neutron-trapping elements such as boron.

13. Container according to claim 1, characterised in that
the fitted elements (20, 22, 24) are connected indirectly or directly to the internal wall of the peripheral wall (12).

14. Container according to claim 1, characterised in that
the fitted element (20, 22, 24) in the form of a tube has an external diameter D of 50 mm≦D≦70 mm, in particular D=60 mm, and/or a wall thickness d of 2 mm≦d≦5 mm, in particular d=3 mm.

15. Container according to claim 1, characterised in that
the fitted element is a rod with an external diameter D of 50 mm≦D≦60 mm.

16. Container according to claim 1, characterised in that
the fitted element is a panel of a thickness preferably between 5 mm to 6 mm, wherein the panel extends over the entire width of the container and has in particular openings for the material to be filled into the container.

17. Container according to claim 1, characterised in that
the volume share of the fitted elements (20, 22, 24) in relation to the interior of the container (10) with tubes as fitted elements lies between 25% and 40% and/or with rods as fitted elements between 25% and 40% and/or with panels as fitted elements 10% to 20%.

18. Container according to claim 1, characterised in that
the container (10) is a container of the type cylinder 30B to ISO 7195 with the fitted elements (20, 22, 24) arranged in its interior (13).
